(19) United States
(12) Patent Application Publication
(10) Pub. No.: US 2021/0149578 A1
(43) Pub. Date: May 20, 2021

(54) Data Restoration Method Used When Terminal Is Restored to Factory Settings, and Terminal

(71) Applicant: Huawei Technologies Co., Ltd., Shenzhen (CN)

(72) Inventors: Shikun Xu, Beijing (CN); Fei Yu, Beijing (CN); Zhongling Chen, Beijing (CN)

(21) Appl. No.: 17/256,858

(22) PCT Filed: Jul. 12, 2018
(86) PCT No.: PCT/CN2018/095487

§ 371 Date: Dec. 29, 2020

(51) Int. Cl. G06F 3/06; H04M 1/724; H04L 12/24

(52) U.S. Cl. CPC G06F 3/0647; G06F 3/0604; H04L 41/0806; H04M 1/724; G06F 3/068

(57) ABSTRACT

A data restoration method includes displaying, by a terminal, a piece of candidate data in response to a first input for enabling, by a user, a function of restoring to factory settings, receiving, by the terminal, a second input for selecting, by the user, to-be-restored data from the candidate data, backing up, by the terminal, the to-be-restored data to target storage space, where the target storage space is not formatted when the factory settings are restored, performing, by the terminal, an operation of restoring to the factory settings, and restoring, by the terminal, the to-be-restored data from the target storage space to an initial storage path of the to-be-restored data.

### TECHNICAL FIELD

This application relates to the terminal field, and in particular, to a data restoration method used when a terminal is restored to factory settings, and a terminal.

### BACKGROUND

Generally, a terminal such as a mobile phone has a function of restoring to factory settings (recovery, also referred to as Restore or resetting a mobile phone). Specifically, this function restores a mobile phone to a factory-default status before the mobile phone is sold. After factory settings are restored, all existing settings, stored and installed applications of the mobile phone, and data in the applications are cleared, and the mobile phone is restored to the original factory-default status.

Generally, to prevent losses of data such as photos, music, and applications on a mobile phone, a user may back up, before restoring the mobile phone to factory settings, the data to an external storage device such as a computer, a secure digital card (secure digital card) of a mobile phone, or a cloud server. After the mobile phone completes the operation of restoring to factory settings, the user can restore the backup data to the mobile phone. It can be learned that an entire operation process of restoring to factory settings is comparatively complex, and a process of backing up and restoring data depends on an external resource such as a Wi-Fi network environment or an external storage device. Consequently, stability and security of data in the entire process of restoring to factory settings are reduced.

### SUMMARY

This application provides a data restoration method used when a terminal is restored to factory settings, and a terminal. Data that a user wants to retain can be quickly and securely restored in a mobile phone after the mobile phone is restored to factory settings. This improves stability and security of the data in the terminal.

To achieve the foregoing objective, the following technical solutions are used in this application.

According to a first aspect, this application provides a data restoration method used when a terminal is restored to factory settings, including: displaying, by the terminal, at least one piece of candidate data in response to a first input of enabling, by a user, a function of restoring to factory settings; receiving, by the terminal, a second input of selecting, by the user, to-be-restored data from the candidate data; and backing up, by the terminal, the selected to-be-restored data to target storage space, where the target storage space is storage space that is not formatted when factory settings are restored. In this case, after performing the operation of restoring to factory settings, the terminal may restore the to-be-restored data from the target storage space to an initial storage path of the to-be-restored data, where the initial storage path is a storage directory in which the to-be-restored data is located before factory settings are restored.

In this way, when a terminal is restored to factory settings, to-be-restored data that a user does not want to clear can be retained. In addition, the backup process and the restoration process of the to-be-restored data are completed by using storage resources in the terminal. Therefore, in the entire process of restoring to factory settings, a terminal may ensure stability and security of to-be-restored data without using an external storage device.

In a possible design method, the candidate data includes at least one of a contact, an SMS message, a picture, a video, a call record, music, and an application.

In a possible design method, before the backing up, by the terminal, the to-be-restored data to target storage space, the method further includes: if a size of the to-be-restored data is less than a size of first remaining space, determining, by the terminal, that the target storage space is unoccupied storage space in a RAM, where the first remaining space is the unoccupied storage space in the RAM of the terminal; if a size of the to-be-restored data is less than a size of second remaining space, determining, by the terminal, that the target storage space is unoccupied storage space in a ROM, where the second remaining space is the unoccupied storage space in the ROM of the terminal; or if a size of the to-be-restored data is greater than the size of the first remaining space, is greater than the size of the second remaining space, and is less than a sum of the size of the first remaining space and the size of the second remaining space, determining, by the terminal, that the target storage space includes the unoccupied storage space in the ROM and the unoccupied storage space in the RAM. In other words, when a terminal is restored to factory settings, target storage space used to back up to-be-restored data is dynamically determined based on a size of the to-be-restored data.

In a possible design method, after the receiving, by the terminal, a second input of selecting, by the user, to-be-restored data from the candidate data, the method further includes: marking, by the terminal, the to-be-restored data. For example, the terminal can record the initial storage path of the to-be-restored data in a preset backup list. In this way, the terminal may learn, by reading the backup list, which data is the to-be-restored data that is selected by the user and that needs to be backed up.

In a possible design method, the backing up, by the terminal, the to-be-restored data to target storage space includes: obtaining, by the terminal, the to-be-restored data based on the initial storage path recorded in the backup list, and copying the to-be-restored data to the target storage space.

In a possible design method, after the receiving, by the terminal, a second input of selecting, by the user, to-be-restored data from the candidate data, the method further includes: comparing, by the terminal, a size of the to-be-restored data with a size of unoccupied storage space in the target storage space; and if the size of the to-be-restored data is greater than the size of the unoccupied storage space in the target storage space, prompting, by the terminal, the user to deselect some of the to-be-restored data.

In a possible design method, before the backing up, by the terminal, the to-be-restored data to target storage space, the method further includes: determining, by the terminal, that the size of the to-be-restored data is not greater than the size of the unoccupied storage space in the target storage space.

In a possible design method, before the backing up, by the terminal, the to-be-restored data to target storage space, the method further includes: creating, by the terminal, a new partition in the ROM of the terminal based on the size of the to-be-restored data, where the new partition is used as the target storage space; and the backing up, by the terminal, the to-be-restored data to target storage space includes: backing up, by the terminal, the to-be-restored data from the original storage space to the new partition.

For example, the new partition includes unoccupied storage space in a data partition in the ROM. Therefore, before the creating, by the terminal, a new partition in the ROM of the terminal based on the size of the to-be-restored data, the method further includes: deleting, by the terminal, data other than the to-be-restored data in the data partition.

In a possible design method, the terminal stores a correspondence between the to-be-restored data in the target storage space and the to-be-restored data in the initial storage path; and the restoring, by the terminal, the to-be-restored data from the target storage space to an initial storage path of the to-be-restored data includes: restoring, by the terminal, the to-be-restored data from the target storage space to the initial storage path of the to-be-restored data according to the correspondence. In this way, even if a name of the to-be-restored data is modified when the to-be-restored data is stored in the target storage space, or a storage structure of the to-be-restored data changes, the terminal can still restore the to-be-restored data in the target storage space to the initial storage path of the to-be-restored data according to the foregoing correspondence.

In a possible design method, after the performing, by the terminal, the operation of restoring to factory settings, the method further includes: displaying, by the terminal, the to-be-restored data list; obtaining, by the terminal, a user's third input, where the third input is used to select to-be-restored data from the to-be-restored data list; and the restoring, by the terminal, the to-be-restored data from the target storage space to an initial storage path of the to-be-restored data includes: restoring, by the terminal, the data selected by the third input to an initial storage path of the data selected by the third input. Therefore, man-machine interaction is more friendly to a user when a mobile phone is restored to factory settings.

According to a second aspect, this application provides a terminal, including an obtaining unit, a display unit, a backup unit, an execution unit, and a restoration unit, where the display unit is configured to display at least one piece of candidate data in response to a first input of enabling, by a user, a function of restoring to factory settings: the obtaining unit is configured to receive a second input of selecting, by the user, to-be-restored data from the candidate data; the backup unit is configured to back up the to-be-restored data to target storage space, where the target storage space is storage space that is not formatted when factory settings are restored; the execution unit is configured to perform the operation of restoring to factory settings; and the restoration unit is configured to restore the to-be-restored data from the target storage space to an initial storage path of the to-be-restored data, where the initial storage path is a storage directory in which the to-be-restored data is located before factory settings are restored.

In a possible design method, the backup unit is further configured to: if a size of the to-be-restored data is less than a size of first remaining space, determine that the target storage space is unoccupied storage space in the RAM, where the first remaining space is the unoccupied storage space in the RAM of the terminal, if a size of the to-be-restored data is less than a size of second remaining space, determine that the target storage space is unoccupied storage space in the ROM, where the second remaining space is the unoccupied storage space in the ROM of the terminal, or if a size of the to-be-restored data is greater than the size of the first remaining space, is greater than the size of the second remaining space, and is less than a sum of the size of the first remaining space and the size of the second remaining space, determine that the target storage space includes unoccupied storage space in the ROM and unoccupied storage space in the RAM.

In a possible design method, the execution unit is further configured to mark the to-be-restored data. For example, the initial storage path of the to-be-restored data is recorded in a preset backup list.

In a possible design method, the backup unit is specifically configured to: obtain the to-be-restored data based on the initial storage path recorded in the backup list, and copy the to-be-restored data to the target storage space.

In a possible design method, the execution unit is further configured to: compare a size of the to-be-restored data with a size of unoccupied storage space in the target storage space, and if the size of the to-be-restored data is greater than the size of the unoccupied storage space in the target storage space, prompt the user to deselect some of the to-be-restored data.

In a possible design method, the execution unit is further configured to create a new partition in the ROM of the terminal based on the size of the to-be-restored data, where the new partition is used as the target storage space; and the backup unit is specifically configured to back up the to-be-restored data from the original storage space to the new partition.

In a possible design method, the new partition includes unoccupied storage space in a data partition in the ROM, and the execution unit is further configured to delete data other than the to-be-restored data in the data partition.

In a possible design method, the terminal stores a correspondence between the to-be-restored data in the target storage space and the to-be-restored data in the initial storage path; and the restoration unit is specifically configured to restore the to-be-restored data from the target storage space to the initial storage path of the to-be-restored data according to the correspondence.

In a possible design method, the display unit is further configured to display the to-be-restored data list; the obtaining unit is further configured to obtain a user's third input, where the third input is used to select to-be-restored data from the to-be-restored data list; and the restoration unit is specifically configured to restore the data selected by the third input to an initial storage path of the data selected by the third input.

According to a third aspect, this application provides a terminal, including a touchscreen, one or more processors, a memory, and one or more programs. The processor is coupled to the memory, and the one or more programs are stored in the memory. When the terminal runs, the processor executes the one or more programs stored in the memory, so that the terminal performs the foregoing data restoration method used when a terminal is restored to factory settings

According to a fourth aspect, this application provides a computer storage medium, including a computer instruction. When the computer instruction runs on a terminal, the terminal is enabled to perform the foregoing data restoration method used when a terminal is restored to factory settings.

According to a fifth aspect, this application provides a computer program product. When the computer program product runs on a computer, the computer is enabled to perform the foregoing data restoration method used when a terminal is restored to factory settings.

It may be understood that, the terminals in the second aspect to the third aspect, the computer storage medium in the fourth aspect, and the computer program product in the fifth aspect that are provided above are all configured to perform the corresponding method provided above. Therefore, for beneficial effects that can be achieved by the terminals, the computer storage medium, and the computer program product, refer to beneficial effects in the corresponding method provided above. Details are not described again herein.

### BRIEF DESCRIPTION OF DRAWINGS

FIG. 1 is a schematic structural diagram 1 of a terminal according to an embodiment of this application;

FIG. 2 is a schematic structural diagram of an internal memory in a terminal according to an embodiment of this application;

FIG. 3 is a schematic architectural diagram of an operating system in a terminal according to an embodiment of this application:

FIG. 4 is a flowchart of a data restoration method used when a terminal is restored to factory settings according to an embodiment of this application:

FIG. 5 is a schematic diagram 1 of a scenario of a data restoration method used when a terminal is restored to factory settings according to an embodiment of this application;

FIG. 6 is a schematic diagram 2 of a scenario of a data restoration method used when a terminal is restored to factory settings according to an embodiment of this application:

FIG. 7 is a schematic diagram 3 of a scenario of a data restoration method used when a terminal is restored to factory settings according to an embodiment of this application;

FIG. 8 is a schematic diagram 4 of a scenario of a data restoration method used when a terminal is restored to factory settings according to an embodiment of this application:

FIG. 9 is a schematic diagram 5 of a scenario of a data restoration method used when a terminal is restored to factory settings according to an embodiment of this application;

FIG. 10 is a schematic diagram 6 of a scenario of a data restoration method used when a terminal is restored to factory settings according to an embodiment of this application;

FIG. 11 is a schematic diagram 7 of a scenario of a data restoration method used when a terminal is restored to factory settings according to an embodiment of this application:

FIG. 12 is a schematic diagram 8 of a scenario of a data restoration method used when a terminal is restored to factory settings according to an embodiment of this application;

FIG. 13 is a schematic structural diagram 2 of a terminal according to an embodiment of this application; and

FIG. 14 is a schematic structural diagram 3 of a terminal according to an embodiment of this application.

### DESCRIPTION OF EMBODIMENTS

The following describes the implementations of the embodiments of this application in detail with reference to accompanying drawings.

A data restoration method used when a terminal is restored to factory settings provided in an embodiment of this application may be applied to the terminal. For example, the terminal may be a mobile phone, a tablet computer, a desktop computer, a laptop computer, a notebook computer, an ultra-mobile personal computer (Ultra-mobile Personal Computer, UMPC), a handheld computer, a netbook, a personal digital assistant (Personal Digital Assistant, PDA), a wearable electronic device, a virtual reality device, or the like. A specific form of the terminal is not specially limited in the embodiments of this application.

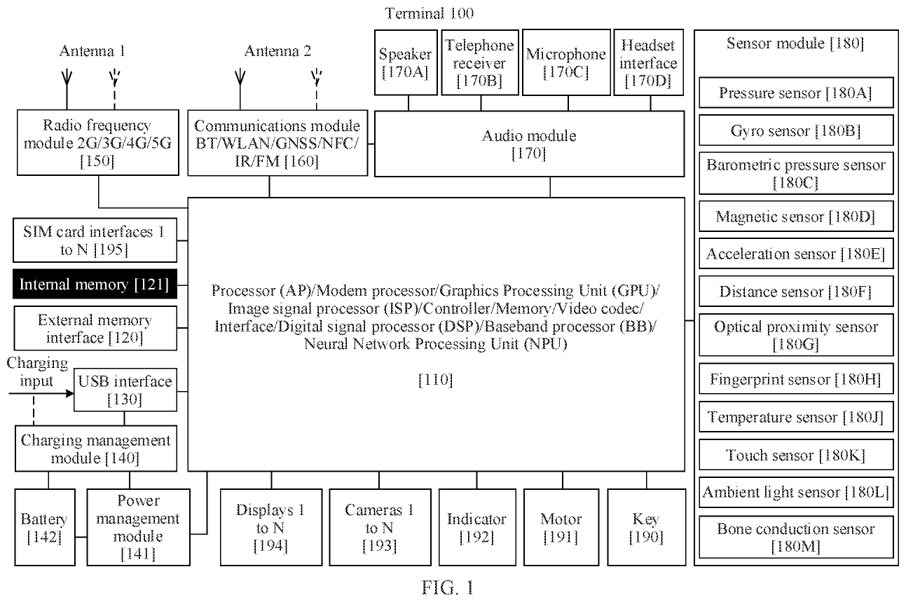

FIG. 1 is a structural block diagram of a terminal 100 according to an embodiment of the present invention.

The terminal 100 may include a processor 110, an external memory interface 120, an internal memory 121, a USB interface 130, a charging management module 140, a power management module 141, a battery 142, an antenna 1, an antenna 2, a radio frequency module 150, a communications module 160, an audio module 170, a speaker 170A, a telephone receiver 170B, a microphone 170C, a headset interface 170D, a sensor module 180, a key 190, a motor 191, an indicator 192, a camera 193, a display 194, a SIM card interface 195, and the like. The sensor module may include a pressure sensor 180A, a gyro sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor, and the like.

The touch sensor 180K, the microphone 170C, the antenna 1, the antenna 2, the radio frequency module 150, the communications module 160, and the like may be used as input devices of the terminal 100, and are configured to receive information entered by a user or another device. The speaker 170A, the telephone receiver 170B, the display 194, and the like may be used as output devices of the terminal 100, and are configured to output various menus of the terminal 100, and information entered by a user or information provided for the user.

A schematic structure in the embodiments of the present invention constitutes no limitation on the terminal 100. The terminal 100 may include more or fewer parts than those shown in the figure, or combine some parts, or split some parts, or have different part arrangements. The components in the figure may be implemented through hardware, software, or a combination of software and hardware.

The processor 110 may include one or more processing units. For example, the processor 110 may include an application processor (application processor, AP), a modem processor, a Graphics Processing Unit (graphics processing unit, GPU), an image signal processor (image signal processor, ISP), a controller, a memory, and a video codec, a digital signal processor (digital signal processor, DSP), a baseband processor, a Neural Network Processing Unit (Neural-network Processing Unit, NPU), and/or the like. Different processing units may be independent devices, or may be integrated into a same processor.

The controller may be a decision maker that directs each part of the terminal 100 to carry out coordinate work based on an instruction. The controller is a nerve center and a command center of the terminal 100. The controller generates an operation control signal based on an instruction operation code and a time sequence signal, to complete control of instruction obtaining and instruction execution.

A memory may further be disposed in the processor 110, and is configured to store an instruction and data. In some embodiments, the memory in the processor is a cache. The memory may store an instruction or data that is just used or cyclically used by the processor. If the processor needs to use the instruction or the data again, the processor may directly invoke the instruction or the data from the memory, to avoid repeated access and reduce a waiting period of time of the processor. Therefore, system efficiency is improved.

In some embodiments, the processor 110 may include an interface. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module. SIM) interface, a universal serial bus (universal serial bus, USB) interface, and/or the like.

The I2C interface is a two-way synchronization serial bus, and includes a serial data line (serial data line, SDA) and a serial clock line (derail clock line, SCL). In some embodiments, the processor may include a plurality of groups of I2C buses. The processor may be coupled to the touch sensor, a charger, a flash light, the camera, and the like through different I2C bus interfaces. For example, the processor may be coupled to the touch sensor through the I2C interface, so that the processor communicates with the touch sensor through the I2C bus interface, to implement a touch function of the terminal 100.

The I2S interface may be configured for audio communication. In some embodiments, the processor may include a plurality of groups of I2C buses. The processor 110 may be coupled to the audio module through the I2S bus, to implement communication between the processor and the audio module. In some embodiments, the audio module may transfer an audio signal to the communications module through the I2S interface, to implement a function of answering a call through a Bluetooth headset.

The PCM interface may also be configured for the audio communication, and sample, quantize, and code an analog signal. In some embodiments, the audio module may be coupled to the communications module through the PCM bus interface. In some embodiments, the audio module may transfer an audio signal to the communications module through the PCM interface, to implement the function of answering a call through a Bluetooth headset. Both the I2S interface and the PCM interface may be configured for the audio communication, and sampling rates of the two interfaces are different.

The UART interface is a universal serial data bus, and is configured for asynchronous communication. The bus is a bidirectional communication bus. The bus performs a conversion between serial communication and parallel communication on to-be-transmitted data. In some embodiments, the UART interface is usually configured to connect the processor to the communications module 160. For example, the processor communicates with a Bluetooth module through the UART interface, to implement a Bluetooth function. In some embodiments, the audio module may transfer an audio signal to the communications module through the UART interface, to implement the function of answering a call through a Bluetooth headset.

The MIPI interface may be configured to connect the processor to a peripheral device such as the display or the camera. The MIPI interface includes a camera serial interface (camera serial interface, CSI), a display serial interface (display serial interface, DSI), and the like. In some embodiments, the processor communicates with the camera through the CSI interface, to implement a photographing function of the terminal 100. The processor communicates with the display through the DSI interface, to implement a display function of the terminal 100.

The GPIO interface may be configured through software. The GPIO interface may be configured as a control signal, or may be configured as a data signal. In some embodiments, the GPIO interface may be configured to connect the processor to the camera, the display, the communications module, the audio module, a sensor, and the like. The GPIO interface may alternatively be configured as the I2C interface, the I2S interface, the UART interface, the MIPI interface, or the like.

The USB interface 130 may be a mini USB port, a micro USB port, a USB Type-C port, or the like. The USB interface may be configured to connect to the charger to charge the terminal 100, or may be configured to transmit data between the terminal 100 and a peripheral device. The USB interface may alternatively be configured to connect to a headset, to play audio through the headset. The USB interface may alternatively be configured to connect to another electronic device such as an AR device.

An interface connection relationship between the modules shown in the embodiments of the present invention is merely an example for description, and does not constitute a limitation on a structure of the terminal 100. The terminal 100 may use different interface connection manners or a combination of a plurality of interface connection manners in this embodiment of the present invention.

The charging management module 140 is configured to receive charging input from the charger. The charger may be a wireless charger or a wired charger. In some embodiments of wired charging, the charging management module may receive charging input from the wired charger through the USB interface. In some embodiments of wireless charging, the charging management module may receive wireless charging input via a wireless charging coil of the terminal 100. When charging the battery, the charging management module may further charge a terminal device through the power management module 141.

The power management module 141 is connected to the battery 142, the charging management module 140, and the processor 110. The power management module receives input of the battery and/or the charging management module, and supplies power to the processor, the internal memory, an external memory, the display, the camera, the communications module, and the like. The power management module may be further configured to monitor parameters such as a battery capacity, a battery cycle count, a status of battery health (electric leakage or impedance). In some embodiments, the power management module 141 may alternatively be disposed in the processor 110. In some embodiments, the power management module 141 and the charging management module may alternatively be disposed in a same device.

A wireless communication function of the terminal 100 may be implemented through the antenna module 1, the antenna module 2, the radio frequency module 150, the communications module 160, a modem, the baseband processor, and the like.

The antenna 1 and the antenna 2 are configured to transmit and receive an electromagnetic wave signal. Each antenna in the terminal 100 may be configured to cover one or more communication bands. Different antennas may further be multiplexed, to improve antenna utilization. For example, a cellular network antenna may be multiplexed as a wireless local area network diversity antenna. In some embodiments, an antenna may be used in combination with a tuning switch.

The radio frequency module 150 may provide a communications processor module that is applied to the terminal 100 and that includes a wireless communication solution such as 2G/3G/4G/5G. The radio frequency module 150 may include at least one filter, a switch, a power amplifier, a low noise amplifier (Low Noise Amplifier, LNA), and the like. The radio frequency module may receive an electromagnetic wave through the antenna 1, perform processing such as filtering or amplification on the received electromagnetic wave, and transfer the electromagnetic wave to the modem for demodulation. The radio frequency module may further amplify a signal modulated by the modem, and convert the signal into an electromagnetic wave for radiation through the antenna 1. In some embodiments, at least some function modules in the radio frequency module 150 may be disposed in the processor 150. In some embodiments, at least some function modules in the radio frequency module 150 may be disposed in a same device as at least some modules in the processor 110.

The modem may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transfers the low-frequency baseband signal obtained through demodulation to the baseband processor for processing. The low-frequency baseband signal is processed by the baseband processor, and is then transferred to the application processor. The application processor outputs a sound signal through an audio device (not limited to the speaker, the telephone receiver, or the like), or displays an image or a video through the display. In some embodiments, the modem may be an independent device. In some embodiments, the modem may be independent of the processor, and is disposed in a same device as the radio frequency module or another function module.

The communications module 160 may provide a communications processor module that is applied to the terminal 100 and that includes a wireless communication solution such as a wireless local area network (wireless local area networks, WLAN), Bluetooth (bluetooth, BT), a Global Navigation Satellite System (global navigation satellite system, GNSS), frequency modulation (frequency modulation, FM), a Near Field Communication (near field communication, NFC) technology, an infrared (infrared, IR) technology, and the like. The communications module 160 may be one or more devices integrating at least one communications processor module. The communications module receives an electromagnetic wave through the antenna 2, performs frequency modulation and filtering processing on an electromagnetic wave signal, and sends a processed signal to the processor. The communications module 160 may further receive a to-be-sent signal from the processor, perform the frequency modulation and amplification on the signal, and convert the signal into an electromagnetic wave for radiation through the antenna 2.

In some embodiments, the antenna 1 of the terminal 100 is coupled to the radio frequency module, and the antenna 2 is coupled to the communications module. In this way, the terminal 100 can communicate with a network and another device through a wireless communications technology. The wireless communications technology may include a global system for mobile communications (global system for mobile communications, GSM), a general packet radio service (general packet radio service, GPRS), code division multiple access (code division multiple access, CDMA), Wideband Code Division Multiple Access (wideband code division multiple access, WCDMA), Time Division-Synchronous Code Division Multiple Access (time-division code division multiple access, TD-SCDMA), Long Term Evolution (long term evolution, LTE), BT, a GNSS, a WLAN, NFC, FM, an IR technology, and/or the like. The GNSS may include a Global Positioning System (global positioning system, GPS), a Global Navigation Satellite System (global navigation satellite system, GLONASS), a BeiDou Navigation Satellite System (beidou navigation satellite system. BDS), a Quasi-Zenith Satellite System (quasi-zenith satellite system, QZSS), and/or a satellite based augmentation system (satellite based augmentation systems, SBAS).

The terminal 100 implements the display function through the GPU, the display 194, the application processor, and the like. The GPU is a microprocessor for image processing, and is connected to the display and the application processor. The GPU is configured to perform mathematical and geometric calculation, and is configured to render an image. The processor 110 may include one or more GPUs that execute a program instruction to generate or change display information.

The display 194 is configured to display an image, a video, and the like. The display includes a display panel. The display panel may use an LCD (liquid crystal display, liquid crystal display), an OLED (organic light-emitting diode, organic light-emitting diode), an active-matrix organic light-emitting diode or an active-matrix organic light-emitting diode (active-matrix organic light emitting diode, AMOLED), a mini-LED, a micro-LED, a micro-OLED, quantum dot light-emitting diodes (quantum dot light emitting diodes, QLED), or the like. In some embodiments, the terminal 100 may include one or N displays, where N is a positive integer greater than 1.

Still as shown in FIG. 1, the terminal 100 may implement the photographing function through the ISP, the camera 193, the video codec, the GPU, the display, the application processor, and the like.

The ISP is configured to process data fed back by the camera. For example, during photographing, a shutter is turned on, and light is transmitted to a photosensitive element of the camera through a lens. An optical signal is converted into an electrical signal, the photosensitive element of the camera transmits the electrical signal to the ISP for processing, and the electrical signal is converted into an image that can be seen. The ISP may further optimize an algorithm for noise, brightness, and complexion of an image. The ISP may further optimize parameters such as exposure and a color temperature of a shooting scenario. In some embodiments, the ISP may be disposed in the camera 193.

The camera 193 is configured to capture a static image or a video. An optical image of an object is generated through the lens, and is projected to the photosensitive element. The photosensitive element may be a charge coupled device (charge coupled device, CCD) or a complementary metal-oxide-semiconductor (complementary metal-oxide-semiconductor. CMOS) photoelectric transistor. The photosensitive element converts the optical signal into the electrical signal, and then transmits the electrical signal to the ISP to convert the electrical signal into a digital image signal. The ISP outputs the digital image signal to the DSP for processing. The DSP converts the digital image signal into a standard image signal in a format such as RGB or YUV. In some embodiments, the terminal 100 may include one or N cameras, where N is a positive integer greater than 1.

The digital signal processor is configured to process a digital signal. In addition to the digital image signal, the digital signal processor may further process another digital signal. For example, when the terminal 100 selects a frequency, the digital signal processor is configured to perform Fourier transform, and the like on frequency energy.

The video codec is configured to compress or decompress a digital video. The terminal 100 may support one or more codecs. In this way, the terminal 100 may play or record videos in a plurality of encoding formats, for example, MPEG 1, MPEG 2, MPEG 3, MPEG 4, and the like.

The NPU is a neural network (neural-network. NN) computing processor that rapidly processes input information by referring to a structure of a biological neural network, for example, by referring to a transfer mode between human brain neurons, and can further perform self-learning continuously. Applications such as intelligent cognition of the terminal 100, such as image recognition, facial recognition, speech recognition, and text understanding, can be implemented through the NPU.

The external memory interface 120 may be configured to be connected to an external storage card such as a micro SD card, to extend a storage capability of the terminal 100. The external storage card communicates with the processor through the external memory interface, to implement a data storage function, for example, files such as music and a video are stored into the external storage card.

The internal memory 121 may be configured to store computer-executable program code, and the executable program code includes an instruction. The processor 110 runs the instruction stored in the internal memory 121, to implement various function applications and data processing of the terminal 100. The memory 121 may include a program storage area and a data storage area. The program storage area may store an operating system, an application program required by at least one function (for example, a voice playing function or an image playing function), and the like. The data storage area may store data (such as audio data and a phone book) created during use of the terminal 100, and the like. In addition, the memory 121 may include a high-speed random access memory, and may further include a nonvolatile memory, for example, at least one magnetic disk storage device, a flash storage device, or another volatile solid-state storage device, a Universal Flash Storage (universal flash storage, UFS), and the like.

In this embodiment of this application, the internal memory 121 may specifically include a RAM (random access memory, random access memory) and a ROM (read-only memory, read-only memory). The RAM is an internal memory that directly exchanges data with the processor 110, and is also referred to as a main memory (or a memory). The RAM may be read or written at any time at a fast speed, and is usually used as a temporary data storage medium of an operating system or another running program. Data stored in the ROM can be easily read, but the ROM is not like the RAM in which data can be quickly and conveniently written. However, the data stored in the ROM is comparatively stable, and the stored data does not change after a power failure. A structure of the ROM is comparatively simple and the data reading is convenient, so that the ROM is usually used to store various permanent programs and data.

The RAM and the ROM may include one or more partitions.

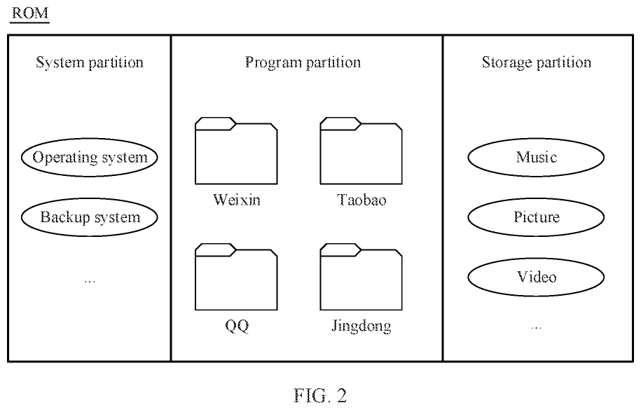

The ROM is used as an example. As shown in FIG. 2, the ROM may include a system partition (for example, the system partition and a recovery partition), a program partition (for example, a data partition), a storage partition (for example, an SD card partition), and the like. The system partition may be used to store resources such as an operating system (for example, an Android system), a restoration and backup system, swap space, and underlying hardware space. The program partition is used to store a third-party application installed on the terminal. For each application, the terminal may correspondingly create a data directory in the data partition. For example, if a package name of an application is referred to as weixin.com, a directory named weixin.com may be created in the data partition. Application data generated during running of the application, such as a chat record and a transferred file, may be stored in the directory named weixin.com. In addition, the application can operate only data in the directory, and cannot operate a directory of another application. The storage partition is similar to a “removable hard disk” that is identified after a mobile phone is connected to a PC. The storage space can be allocated by the user, and can be used to store data such as music, pictures, videos, and data packets of large games.

The terminal 100 may further dynamically create a new partition in the RAM or the ROM. For example, if 2 GB of space in a ROM of 4 GB is not occupied, the terminal 100 may create a partition named “aaa” in the 2 GB of space. Certainly, the terminal 100 may alternatively dynamically destroy the newly created partition, and data in the partition is also destroyed after the new partition is destroyed.

In the embodiments of this application, when the terminal 100 is restored to factory settings, usually one or more partitions in the ROM of the terminal 100 are formatted (format). For example, the terminal 100 may format the data partition in the ROM, and delete all files and folders in the data partition. Therefore, all applications installed in the data partition and data in each application are cleared, and the terminal 100 is restored to a factory-default status at which the terminal 100 is set for sale.

The terminal 100 may implement an audio function through the audio module 170, the speaker 170A, the telephone receiver 170B, the microphone 170C, the headset interface 170D, the application processor, and the like. The audio function includes playing of music, recording, and the like.

The audio module is configured to convert digital audio information into an analog audio signal, and is also configured to convert the analog audio signal into a digital audio signal. The audio module may be further configured to encode and decode an audio signal. In some embodiments, the audio module may be disposed in the processor 110, or some function modules in the audio module are disposed in the processor 110.

The speaker 170A, also referred to as a “horn”, is configured to convert an audio electrical signal into a sound signal. The terminal 100 may play music through the speaker, or receive a hands-free call.

The telephone receiver 170B, also referred to as an “earpiece”, is configured to convert an audio electrical signal into a sound signal. When a call is answered or an audio message is received through the terminal 100, the telephone receiver may be put close to a human ear to receive voice.

The microphone 170C, also referred to as a “mike” or a “voice transmitter”, is configured to convert a sound signal into an electrical signal. When making a call or sending a voice message, a user may make a sound by moving a user's mouth near the microphone to input a sound signal to the microphone. At least one microphone may be disposed in the terminal 100. In some embodiments, two microphones may be disposed in the terminal 100, to collect a sound signal and further implement a noise reduction function. In some embodiments, alternatively, three, four, or more microphones may be disposed in the terminal 100, to collect a sound signal, reduce noise, and further identify a sound source, implement a directional recording function, and the like.

The headset interface 170D is configured to connect to a wired headset. The headset interface may be a USB interface, or may be a 3.5 mm Open Mobile Terminal Platform (open mobile terminal platform. OMTP) standard interface or a Cellular Telecommunications Industry Association of the USA (cellular telecommunications industry association of the USA. CTIA) standard interface.

The pressure sensor 180A is configured to sense a pressure signal, and can convert the pressure signal into an electrical signal. In some embodiments, the pressure sensor may be disposed on the display. There are many types of pressure sensors such as a resistive pressure sensor, an inductive pressure sensor, a capacitive pressure sensor, and the like. The capacitive pressure sensor may include at least two parallel plates made of a conductive material. Capacitance between electrodes changes when force is applied to the pressure sensor. The terminal 100 determines pressure strength based on a capacitance change. When a touch operation is performed on the display, the terminal 100 detects strength of the touch operation through the pressure sensor. The terminal 100 may also calculate a touch position based on a detection signal of the pressure sensor. In some embodiments, touch operations that are applied to a same touch position but have different touch operation strength may correspond to different operation instructions. For example, when a touch operation in which touch operation strength is less than a first pressure threshold is performed on an SMS message application icon, an instruction for viewing an SMS message is executed. When a touch operation in which touch operation strength is greater than or equal to the first pressure threshold is performed on the SMS message application icon, an instruction for creating a new SMS message is executed.

The gyro sensor 180B may be configured to determine a moving posture of the terminal 100. In some embodiments, angular velocities of the terminal 100 around three axes (namely, x, y, and z axes) may be determined through the gyro sensor. The gyro sensor may be used for image stabilization during photographing. For example, when the shutter is pressed, the gyro sensor detects an angle at which the terminal 100 jitters, calculates, based on the angle, a distance for which a lens module needs to compensate, and allows the lens to cancel the jitter of the terminal 100 through reverse motion, to implement the image stabilization. The gyro sensor may also be used for navigation and a somatic game scenario.

The barometric pressure sensor 180C is configured to measure barometric pressure. In some embodiments, the terminal 100 calculates an altitude through a barometric pressure value measured by the barometric pressure sensor, to assist positioning and the navigation.

The magnetic sensor 180D includes a Hall sensor. The terminal 100 may detect opening and closing of a flip leather case through the magnetic sensor. In some embodiments, when the terminal 100 is a clamshell phone, the terminal 100 may detect opening and closing of a flip cover through the magnetic sensor. Further, a feature such as automatic unlocking of the flip cover is set based on a detected opening or closing state of the leather case or a detected opening or closing state of the flip cover.

The acceleration sensor 180E may detect values of accelerations in various directions (there are usually three axes) of the terminal 100. When the terminal 100 is still, a value and a direction of gravity may be detected. The acceleration sensor 180E may be further configured to identify a posture of the terminal, and is applied to applications such as a pedometer and screen switching between a landscape mode and a portrait mode.

The distance sensor 180F is configured to measure a distance. The terminal 100 may measure a distance through infrared light or a laser. In some embodiments, in a shooting scenario, the terminal 100 may use the distance sensor to measure a distance, to implement fast focusing.

The optical proximity sensor 180 may include, for example, a light emitting diode (LED) and an optical detector such as a photodiode. The light emitting diode may be an infrared light emitting diode, and the light emitting diode is configured to emit infrared light outward. The photodiode is configured to detect infrared reflected light from a nearby object. When sufficient reflected light is detected, it may be determined that there is an object near the terminal 100. When insufficient reflected light is detected, it may be determined that there is no object near the terminal 100. The terminal 100 may detect, through the optical proximity sensor, that the user holds the terminal 100 close to an ear to make a call, to automatically turn off the screen for power saving. The optical proximity sensor may also be used in a smart cover mode or a pocket mode to automatically unlock or lock a screen.

The ambient light sensor 180L is configured to sense ambient light brightness. The terminal 100 may adaptively adjust brightness of the display based on the sensed ambient light brightness. The ambient light sensor may also be configured to automatically adjust a white balance during photographing. The ambient light sensor may also cooperate with the optical proximity sensor to detect whether the terminal 100 is in a pocket to prevent a false touch.

The fingerprint sensor 180H is configured to collect a fingerprint. The terminal 100 may use a feature of the collected fingerprint to implement fingerprint unlocking, accessing of application lock, fingerprint photographing, fingerprint receiving a call and answering a call, and the like.

The temperature sensor 180J is configured to detect a temperature. In some embodiments, the terminal 100 executes a temperature processing policy based on the temperature detected by the temperature sensor 180. For example, when the temperature reported by the temperature sensor exceeds a threshold, the terminal 100 lowers performance of a processor located near the temperature sensor, to reduce power consumption to implement thermal protection.

The touch sensor 180K is also referred to as a “touch panel”, may be set on the display, and is configured to detect a touch operation performed on or near the touch sensor 180K. The touch sensor 180K may transfer the detected touch operation to the application processor, to determine a type of the touch event, and to provide corresponding visual output through the display.

The bone conduction sensor 180M may obtain a vibration signal. In some embodiments, the bone conduction sensor may obtain a vibration signal of a vibration bone of a human vocal part. The bone conduction sensor may also contact a body pulse to receive a blood pressure beating signal. In some embodiments, the bone conduction sensor may be disposed in a headset. The audio module 170 may obtain, based on the vibration signal that is of the vibration bone of the vocal part and that is obtained by the bone conduction sensor, a voice signal through parsing, to implement a voice function. The application processor may parse heart rate information based on the blood pressure beating signal obtained by the bone conduction sensor, to implement a heart rate detection function.

The key 190 includes a power key, a volume key, and the like. The key 190 may be a mechanical key, or may be a touch key. The terminal 100 receives key input, and generates key signal input related to a user setting and function control of the terminal 100.

The motor 191 may generate a vibration prompt. The motor may be used for an incoming call vibration prompt, or may be used for a touch vibration feedback. For example, touch operations performed on different applications (for example, a photographing application and an audio playing application) may correspond to different vibration feedback effects. Different touch operations performed on different areas on the display may correspond to different vibration feedback effects. Different application scenarios (for example, a time reminder, information receiving, an alarm clock, a game, and the like) may also correspond to different vibration feedback effects. Customization of a touch vibration feedback effect may further be supported.

The indicator 192 may be an indicator light that may be configured to indicate a charging status and a battery power change, and may further be configured to indicate a message, a missed call, a notification, and the like.

The SIM card interface 195 is configured to be connected to a subscriber identity module (subscriber identity module, SIM). A SIM card may be inserted into the SIM card interface or removed from the SIM card interface, to implement contact with or separation from the terminal 100. The terminal 100 may support one or N SIM card interfaces, where N is a positive integer greater than 1. The SIM card interface may support a nano-SIM card, a micro-SIM card, a SIM card, and the like. A plurality of cards may be inserted into a same SIM card interface at the same time. The plurality of cards may be of a same type or different types. The SIM card interface may also be compatible with different types of SIM cards, and the SIM card interface may also be compatible with an external storage card. The terminal 100 interacts with a network via a SIM card, to implement functions such as calling and data communication. In some embodiments, the terminal 100 uses an eSIM, namely, an embedded SIM card. The eSIM card may be embedded in the terminal 100, and cannot be separated from the terminal 100.

A software system of the terminal 100 may use a layered architecture, an event-driven architecture, a microkeRNel architecture, a microservice architecture, or a cloud architecture. In this embodiment of the present invention, an Android system with the layered architecture is used as an example to illustrate a software structure of the terminal 100.

In the layered architecture, software is divided into several layers, and each layer has a clear role and task. The layers communicate with each other through an interface. In some embodiments, the Android system is divided into four layers: an application program layer, an application program framework layer, an Android runtime and a system library, and a kernel layer from top to bottom.

The application program layer may include a series of application program packages.

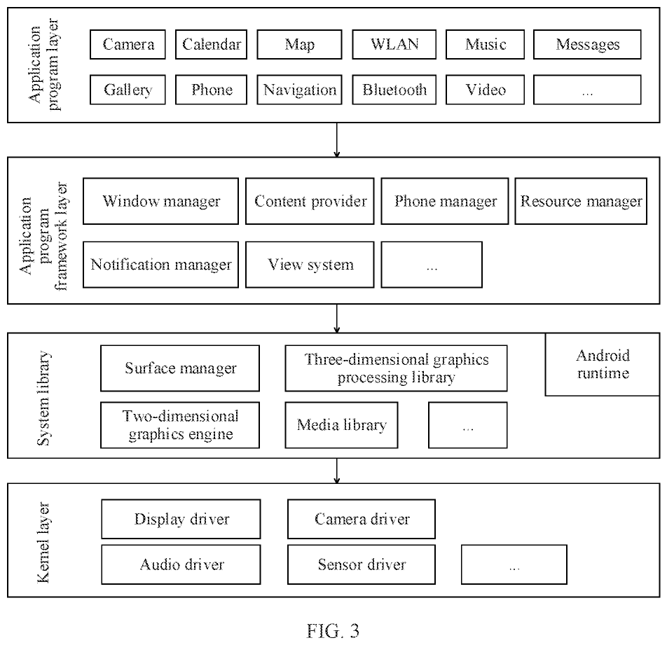

As shown in FIG. 3, the application packages may include application programs such as camera, gallery, calendar, phone, map, navigation, WLAN, Bluetooth, music, video, and SMS message.

These application programs may be system-level applications (for example, desktop, SMS message, phone, calendar, contact, and the like), or may be general-level applications (for example. WeChat, Taobao, and the like). The system-level application usually means that the application has system-level permission and can obtain various system resources. The general-level application usually means that the application has general permission and may not be able to obtain some system resources, or the application can obtain some system resources only after being authorized by a user. The system-level application may be an application pre-installed on a mobile phone. The general-level application may be an application pre-installed on a mobile phone, or may be an application subsequently installed by the user.

The application program framework layer provides an application programming interface (application programming interface, API) and a programming framework for an application program at the application program layer. The application program framework layer includes some predefined functions.

As shown in FIG. 3, the application program framework layer may include an activity manager, a window manager, a content provider, a view system, a resource manager, a notification manager, and the like. This is not limited in the embodiments of this application.

The activity manager is configured to manage a lifecycle of each application. An application usually runs in an operating system in a form of an activity. For each activity, there is a corresponding application record (ActivityRecord) in the activity manager, and the ActivityRecord records a status of the activity of the application. The activity manager may use the ActivityRecord as an identifier to schedule an activity process of the application.

The window manager is configured to manage graphical user interface (graphical user interface, GUI) resources used on a screen, and may be specifically configured to: obtain a size of a display, create and destroy a window, display and hide a window, arrange a window, manage a focus, manage an input method and wallpaper, and the like.

The content provider is configured to: store and obtain data, and make the data accessible to an application program. The data may include a video, an image, audio, calls that are made and answered, a browsing history and a bookmark, a phonebook, and the like.

The view system includes visual controls such as a control for displaying a text and a control for display a picture, and the view system may be configured to construct an application program. The display interface may include one or more views. For example, a display interface including an SMS message notification icon may include a view for displaying a text and a view for displaying a picture.

The resource manager provides various resources such as a localized character string, an icon, a picture, a layout file, and a video file for an application program.

The notification manager enables an application program to display notification information in a status bar, and may be configured to convey a notification-type message. The notification-type message may automatically disappear after the message is displayed for a short period of time without user interaction. For example, the notification manager is configured to provide a notification of download completion, a message notification, and the like. The notification manager may alternatively be a notification that appears on a top status bar of a system in a form of a graph or a scroll bar text, for example, the notification may be a notification of a background application program, or may be a notification that appears on a screen in a form of a dialog window. For example, text information is prompted in the status bar, a prompt tone is produced, the terminal vibrates, or the indicator light blinks.

As shown in FIG. 3, the Android runtime includes a kernel library and a virtual machine. The Android runtime is responsible for scheduling and management of the Android system. The kernel library includes two parts: a function that needs to be invoked by the Java language and a kernel library of Android. The application program layer and the application program framework layer run on the virtual machine. The virtual machine executes a Java file at the application program layer and the application program framework layer as a binary file. The virtual machine is configured to perform functions such as object lifecycle management, stack management, thread management, security and exception management, and garbage collection.

As shown in FIG. 3, the system library may include a plurality of function modules, for example, a surface manager (surface manager), a media library (Media Libraries), OpenGL ES, SGL, and the like.

The surface manager is configured to: manage a display subsystem, and provide fusion of 2D and 3D layers for a plurality of applications.

The media library supports playback and recording in a plurality of commonly used audio and video formats, static image files, and the like. The media library may support a plurality of audio and video encoding formats, for example, MPEG 4, H.264, MP3, AAC, AMR, JPG, PNG, and the like.

OpenGL ES is configured to implement three-dimensional graphics drawing, image rendering, composition, layer processing, and the like.

SGL is a 2D drawing engine.

As shown in FIG. 3, the kernel layer is a layer between hardware and software. The kernel layer includes at least a display driver, a camera driver, an audio driver, and a sensor driver.

Application data generated when each application at the application program laver runs may be stored in a corresponding directory or folder in the ROM. In addition, a phone manager application that is used to manage an application and a file in a terminal may be installed at the application program layer. Generally, the phone manager application provides functions such as “Restore” or “Reset phone”, for restoring a terminal to factory settings.

The function of restoring a terminal to factory settings is actually a standard ROM flashing protocol defined by Android. After a user enables the function of restoring to factory settings, the terminal can be started and enter a recovery (recovery) mode. In the recovery mode, the terminal may execute a related program in the recovery partition in the ROM, for example, a recovery program. Through the recovery program, the terminal can complete operations such as clearing data and installing a ROM flashing package.

In this embodiment of this application, if the terminal detects that the user enables the function of “Restore” or “Reset phone” from the phone manager application, the terminal may prompt the user to select to-be-restored data that the user wants to back up, for example, a photo, a video, contacts, an application, and the like. The to-be-restored data selected by the user is actually stored in the data partition in the ROM. To prevent a data loss caused by formatting the data partition when the terminal is restored to factory settings, the terminal may first back up the to-be-restored data to storage space (which may be referred to as target storage space in this application) other than the data partition. For example, the to-be-restored data may be backed up to the RAM of the terminal, or the to-be-restored data may be backed up to another partition in the ROM. Further, the terminal may enter the recovery mode, and execute a corresponding recovery program to format data in the data partition, so that the terminal is reset to a factory-default status.

After formatting the data in the data partition, the terminal may prompt the user to restore, to the data partition, the to-be-restored data that has been backed up, so that when a mobile phone is restored to factory settings, data such as an application that the user does not want to clear can be retained. In addition, the backup process and the restoration process of the to-be-restored data are completed by using storage resources in the terminal. Therefore, in the entire process of restoring to factory settings, a terminal may ensure stability and security of to-be-restored data without using an external storage device.

In addition, after the terminal restores, to the data partition, the to-be-restored data that has been backed up, the terminal may delete the to-be-restored data in the target storage space, to prevent the to-be-restored data from occupying storage resources that are of the terminal and that are for subsequent normal use.

For ease of understanding, the following specifically describes, with reference to the accompanying drawings, a data restoration method used when a terminal is restored to factory settings according to an embodiment of this application. In the following embodiments, that a mobile phone is used as a terminal is used as an example for description.

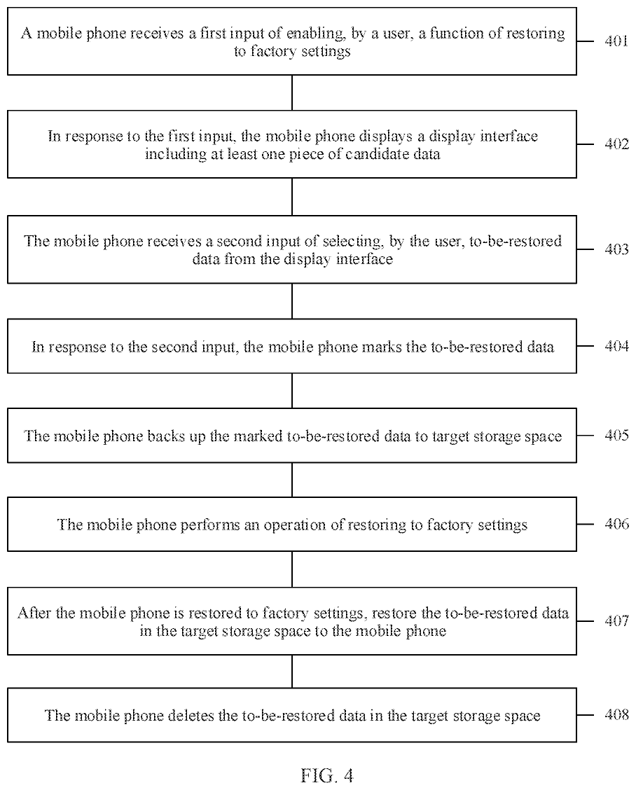

FIG. 4 is a schematic flowchart of a data restoration method used when a terminal is restored to factory settings according to an embodiment of this application; As shown in FIG. 4, the data restoration method may include the following steps.

S401: A mobile phone receives a first input of enabling, by a user, a function of restoring to factory settings.

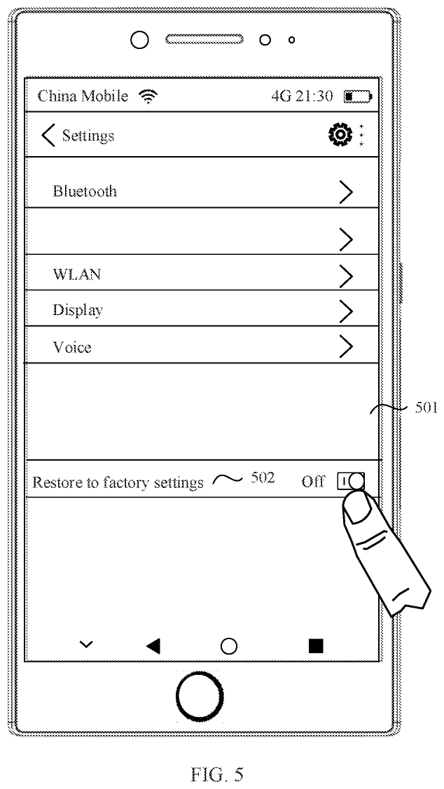

If the user wants to restore the mobile phone to a factory-default status, the user may enter a settings interface of the mobile phone or open a phone manager application to search for a function option of restoring to factory settings. As shown in FIG. 5, an option 502 used to restore to factory settings is provided in a setting interface 501. When the mobile phone detects that the user enables the option 502, it indicates that the user performs the first input of enabling the function of restoring to factory settings. In this case, the mobile phone may continue to perform the following steps S402 to S408 to complete a data backup and restoration operation before and after the mobile phone is restored to factory settings.

S402: In response to the first input, the mobile phone displays a display interface including at least one piece of candidate data.

The candidate data is usually stored in a ROM of the mobile phone. For example, the candidate data is stored in a data partition in the ROM. For example, a video downloaded by the user through a video application 1 is usually stored in a folder that is corresponding to the video application 1 and that is in the data partition, and a video downloaded by the user through a video application 2 is usually stored in a folder that is corresponding to the video application 2 and that is in the data partition. However, when the mobile phone is restored to factory settings, all data in the data partition is formatted, therefore, user's data is lost.

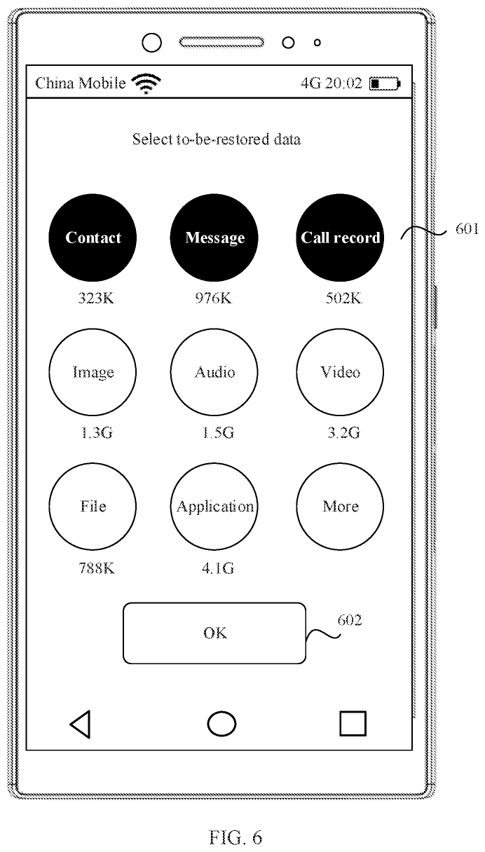

Therefore, after the mobile phone receives the first input, as shown in FIG. 6, the mobile phone may jump to a display interface 601 including to-be backed up candidate data. The user may select, from the display interface 601, to-be-restored data that the user wants to retain when factory settings are restored. For example, the display interface 601 includes at least one piece of candidate data such as a contact, an SMS message, a photo, a call record, music, and an application. When an application is used as the candidate data, the candidate data may specifically include the application program itself, and may further include recorded data and a stored file that are generated in a process of the user using the application, for example, a contact profile picture, a buffered picture, a downloaded picture, and the like. In addition, also as shown in FIG. 6, the mobile phone may further display, in the display interface 601, a size of storage space occupied by each piece of candidate data.

Certainly, after the user selects a piece of candidate data from the display interface 601, the mobile phone may further jump to a detail interface of the piece of candidate data. For example, after the user selects the application from the display interface 601, the mobile phone may display all applications (for example, 15 applications) currently installed on the mobile phone. In this way, the user may select, from these applications, specific applications to be backed up, to avoid losses of corresponding applications after the mobile phone is restored to factory settings.

In addition, after the mobile phone receives the first input, the mobile phone may further query whether the candidate data is stored in the data partition in the ROM. If the candidate data is not stored, no data loss is caused after the mobile phone is restored to factory settings. Therefore, the mobile phone may format data in the ROM based on an existing procedure of restoring to factory settings. Correspondingly, if the candidate data is stored, the mobile phone may display, according to the method described in step S402, the display interface that includes at least one piece of candidate data.

S403: The mobile phone receives a second input of selecting, by the user, to-be-restored data from the display interface.

One or more pieces of candidate data selected by the user in the display interface are to-be-restored data that needs to be backed up and restored before and after the mobile phone is restored to factory settings.

The display interface 601 shown in FIG. 6 is still used as an example. In step S403, if the mobile phone detects that the user taps three pieces of candidate data; the contact, the SMS message, and the call record on the display interface 601, and the mobile phone detects that the user taps an OK button 602, it indicates that the user performs the second input. In this case, the mobile phone may determine that the contact, the SMS message, and the call record that are stored in the ROM are the to-be-restored data that is to be backed up. Certainly, the second input may alternatively be a drag operation, a touch and hold operation, a press operation, or the like. This is not limited in the embodiments of this application.

S404: In response to the second input, the mobile phone marks the to-be-restored data.

After the mobile phone receives the second input, the mobile phone may mark the to-be-restored data selected by the user, so that the mobile phone can distinguish, when the mobile phone is subsequently restored to factory settings, which data the user wants to retain.

For example, the mobile phone may create a backup list, and record a specific storage path of the to-be-restored data in the backup list. For example, if the to-be-restored data selected by the user includes an application A and an application B, the mobile phone may record, in the backup list, a storage path “data/app/taobao.com” that is of the application A and that is in the ROM, and record, in the backup list, a storage path “data/app/weixin.com” that is of the application B and that is in the ROM. In this way, the mobile phone may learn, by reading the backup list, which data is the to-be-restored data that is selected by the user and that needs to be backed up.

Alternatively, the mobile phone may add a corresponding identifier to the to-be-restored data selected by the user. For example, a header file may be added to a file in which the to-be-restored data is located, or an identifier file may be added to a folder in which the to-be-restored data is located. In this way, the mobile phone may learn, by reading the header file or the identifier file, which data is the to-be-restored data that is selected by the user and that needs to be backed up.

S405: The mobile phone backs up the marked to-be-restored data to target storage space.

The target storage space may be any storage space that is other than the data partition in the ROM and that is in the mobile phone. For example, the target storage space may be a RAM of the mobile phone, or the mobile phone may dynamically create a new partition as the target storage space. When the mobile phone performs the operation of restoring to factory settings, the data in the target storage space is not formatted.

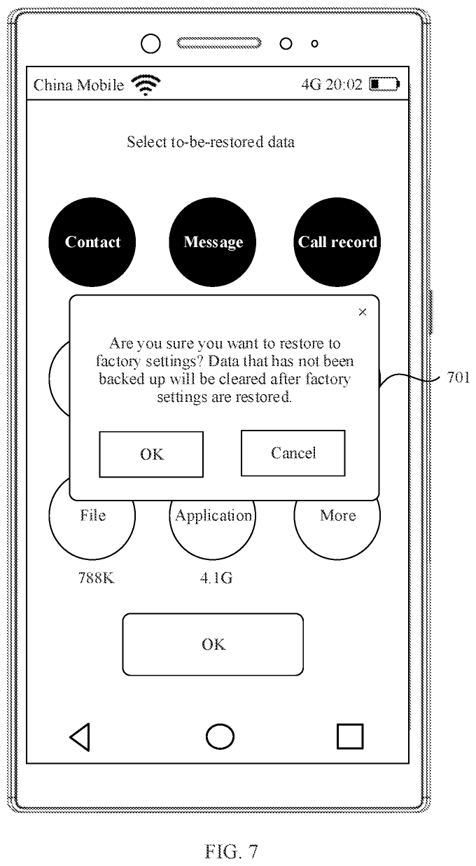

An Android operating system is used as an example. Running modes of the mobile phone usually include a normal mode (normal mode), a safe mode (safe mode), a bootloader mode (bootloader mode), a recovery mode (recovery mode), and the like. After the mobile phone marks the to-be-restored data, the mobile phone may automatically enter the recovery mode. Alternatively, the mobile phone may enter the recovery mode after the user manually confirms to restore the mobile phone to factory settings. For example, after the mobile phone marks the to-be-restored data, as shown in FIG. 7, the mobile phone may display a dialog box 701 to prompt the user to confirm whether to perform the operation of restoring to factory settings. If the user clicks OK to perform the operation of restoring to factory settings, the mobile phone may be automatically powered off, and enter the recovery mode after the mobile phone is automatically powered on.

After the mobile phone enters recovery mode, the mobile phone can check whether the marked to-be-restored data is stored in the mobile phone. For example, the mobile phone may read the backup list created in step S404. If the marked to-be-restored data is recorded in the backup list, it indicates that the to-be-restored data needs to be backed up before the mobile phone is restored to factory settings. This prevents the to-be-restored data from being lost after factory settings are restored. Otherwise, the mobile phone can directly perform the operation of restoring to factory settings.

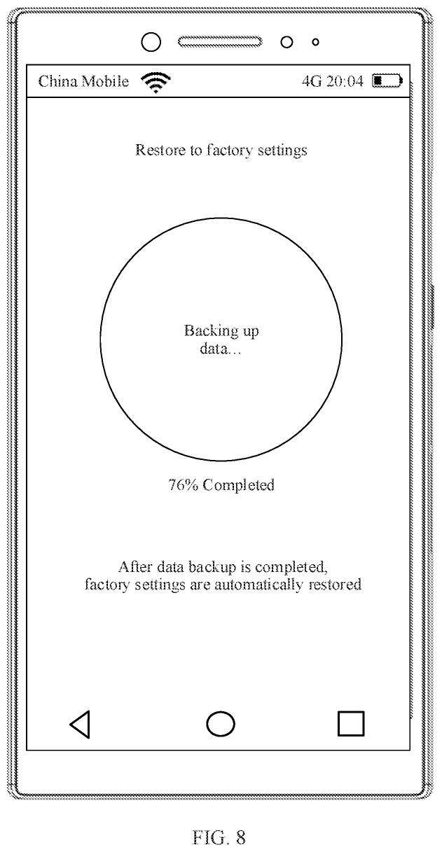

In addition, when the mobile phone marks the to-be-restored data in step S404, the mobile phone may further calculate a size of space required for backing up the to-be-restored data. For example, the target storage space is the RAM of the mobile phone. If the size of the space required by the to-be-restored data is less than or equal to a size of available storage space in the RAM, as shown in FIG. 8, after entering the recovery mode, the mobile phone may jump to an interface 801, and the interface 801 prompts the user that the to-be-restored data selected by the user is being backed up. In addition, the mobile phone may read, based on the storage path recorded in the backup list, the to-be-restored data selected by the user, and then copy the to-be-restored data to the RAM to complete the backup.

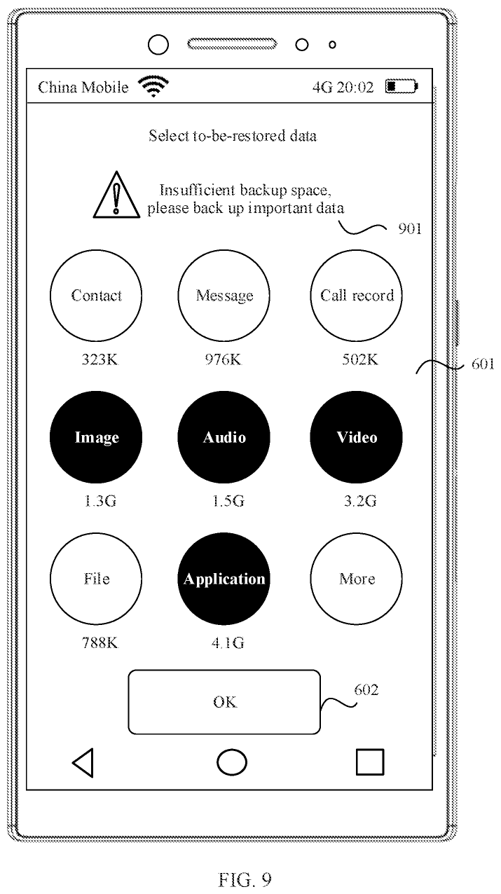

If the mobile phone calculates that the size of the space required by the to-be-restored data is less than the size of the available storage space in the RAM, the mobile phone may first perform a memory cleanup operation to release as much space in the RAM as possible. After the memory cleanup operation is performed, if a size of the available storage space in the RAM still cannot meet the size of the space required by the to-be-restored data, the mobile phone may continue to stay on the display interface 601. In this case, as shown in FIG. 9, the mobile phone may display a prompt 901 on the display interface 601, to prompt the user that the available backup space is insufficient and the user needs to deselect some to-be-restored data. The user may deselect, on the display interface 601 based on the prompt 901, one or more pieces of to-be-restored data that are to be backed up and that are selected in step S403, until the size of the available storage space in the RAM can meet a size of space required by to-be-restored data that is updated by the user. Further, as shown in FIG. 8, after entering the recovery mode, the mobile phone may read, based on the storage path recorded in the backup list, the to-be-restored data that is finally updated by the user, and copy the to-be-restored data to the RAM to complete the backup.

For example, the mobile phone may copy to-be-restored data in the data partition in the ROM to a tmp partition in the RAM. The tmp partition is usually used to store temporary files generated when the mobile phone runs. The mobile phone can be prevented, by copying the to-be-restored data to the tmp partition, from occupying extra system resources when backing up the to-be-restored data and increasing load of the mobile phone in the recovery mode.

In some other embodiments of this application, after the mobile phone enters the recovery mode, if the mobile phone determines, by reading the backup list, that to-be-restored data selected by the user needs to be backed up, the mobile phone may create, based on a size of space required by the to-be-restored data, a new partition, for example, a resume partition in free storage space in the ROM. In this case, the newly created resume partition is the target storage space.

For example, a size of the ROM of the mobile phone is 128 GB. There is 80 GB remaining space in unoccupied storage space other than the data partition, and the size of the space required by the to-be-restored data is 20 GB. In this case, the mobile phone may create a 20 GB resume partition in the 80 GB remaining storage space. Further, the mobile phone may read the to-be-restored data based on the storage path recorded in the backup list, and copy the to-be-restored data to the newly created resume partition to complete the backup.

Alternatively, because storage space of the data partition is generally comparatively large, the mobile phone may also create a new partition in the data partition as the target storage space. For example, a size of the data partition in the ROM is 90 GB, and there are 30 GB unoccupied storage space in the data partition. If a size of the to-be-restored data selected by the user is 15 GB, the mobile phone may create a 15 GB resume partition in the 30 GB unoccupied storage space, to store the to-be-restored data. In this case, after the new partition is created, the size of the data partition changes from 90 GB to 75 GB. For another example, if the 15 GB to-be-restored data selected by the user is greater than a size of remaining storage space in the data partition, the mobile phone may delete data other than the to-be-restored data in the data partition, to release storage resources in the data partition. Further, the mobile phone may create, in the data partition, a resume partition whose size meets the size of the to-be-restored data, to store the to-be-restored data.

Certainly, the mobile phone may alternatively obtain a part of storage resources from the data partition in the ROM, obtain a part of storage resources (for example, 5 GB unoccupied storage space) from another partition (for example, a system partition) other than the data partition, and then create a new resume partition by using the two parts of storage resources.

Alternatively, the target storage space may include both the RAM of the mobile phone and the newly created resume partition. In this way, the mobile phone may back up a part of the to-be-restored data to the RAM, and back up another part of the to-be-restored data to the newly created resume partition. In this way, the user may use the target storage space to back up as much to-be-restored data as possible.

In addition, when copying the to-be-restored data to the target storage space, the mobile phone may further first compress the to-be-restored data, to reduce a size of the target storage space occupied by the to-be-restored data as much as possible. Alternatively, the mobile phone may first encrypt the to-be-restored data, to improve security when the mobile phone copies the to-be-restored data.

S406: The mobile phone performs an operation of restoring to factory settings.

In step S406, the mobile phone may continue to use an existing method for restoring to factory settings, and format, in the recovery mode, the data partition in the ROM. After the formatting, both files and folders in the data partition are erased. In addition, in the recovery mode, the mobile phone may further reset each setting of the operating system to an initial default setting. Therefore, the mobile phone is reset to a factory-default status at which the mobile phone is set for sale.

S407: After the mobile phone is restored to factory settings, restore the to-be-restored data in the target storage space to the mobile phone.

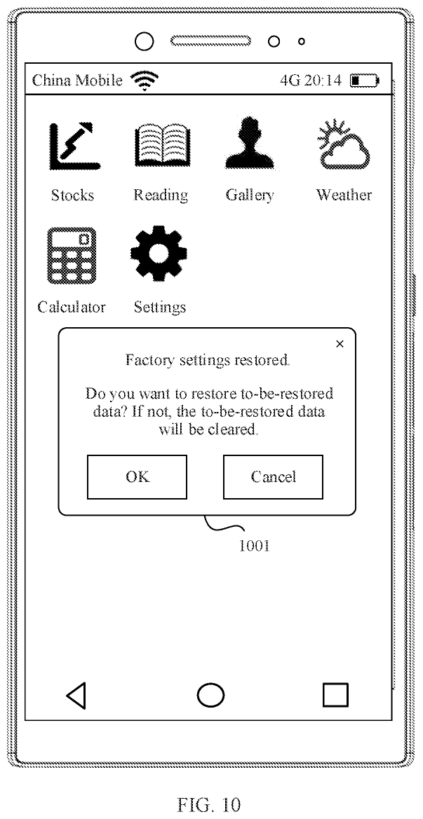

After the mobile phone is restored to factory settings, a dialog box 1001 shown in FIG. 10 may be displayed, to prompt the user to restore, to the mobile phone to which factory settings are reset, the to-be-restored data that is backed up before factory settings are restored. If the user determines to restore the to-be-restored data, the mobile phone may read the to-be-restored data from the target storage space, and copy the to-be-restored data to the data partition in the ROM.

In some embodiments of this application, after backing up the to-be-restored data to the target storage space, the mobile phone may establish a correspondence between the to-be-restored data backed up in the target storage space and the to-be-restored data in the data partition. In this way, in step S407, when restoring the original to-be-restored data in the data partition, the mobile phone may restore, according to the correspondence, to-be-restored data of each backup to a corresponding location in the data partition.

For example, to-be-backed up data named a in an original storage path (for example, a storage path in the data partition) A is stored in a location B in the target storage space. Therefore, a correspondence between “A†a” and “B†a” is recorded. During restoration, the data that is named a and that is at the location B in the target storage space may be restored to the original storage path A according to the correspondence, where the name is still a.

For another example, the to-be-backed up data that is named a and that is in the original storage path A is stored to the location B in the target storage space, and is renamed as b. In this case, a correspondence between “A†a” and “B†b” is recorded. During restoration, the data that is named b and that is at the location B in the target storage space may be restored to the original storage path A according to the correspondence, where the name is modified to a.

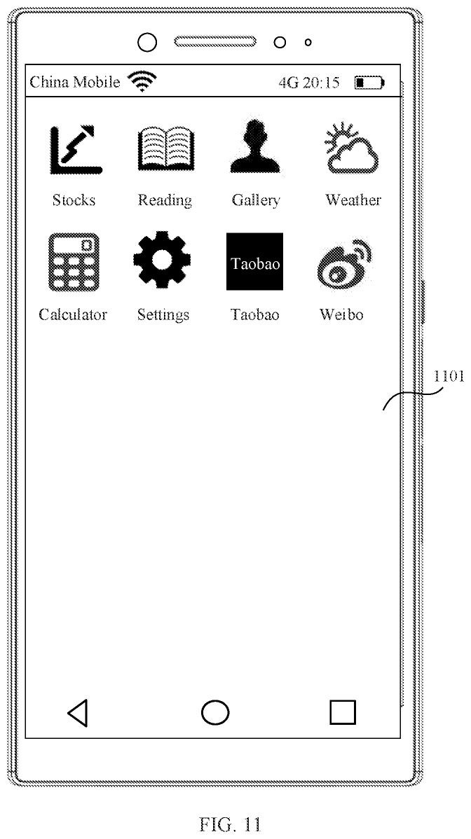

For example, the mobile phone may use the backup list created when the to-be-restored data is backed up as the foregoing correspondence. In most cases, when the mobile phone backs up to-be-restored data in the target storage space, a name of the to-be-restored data and a storage structure of the to-be-restored data are not modified. For example, when backing up a folder named “weibo.com” in an “app” folder in the data partition, the mobile phone still uses “weibo.com” as a name of the folder to copy content in the folder to the target storage space. When restoring the folder, the mobile phone may copy, based on a storage path recorded in the backup list, the folder named “weibo.com” of a Weibo application and a folder named “taobao.com” of a Taobao application that are stored in the target storage space to a folder named “app” in the data partition of the ROM. Certainly, if there is no folder named “app” after the data partition is formatted, the mobile phone may first create the folder named “app”, and then copy the folder named “weibo.com” of the Weibo application and the folder named “taobao.com” of the Taobao application to the newly created folder named “app” in the data partition. In this case, as shown in FIG. 11, the restored Weibo application and the restored Taobao application are re-displayed on a desktop 1101. Because data in the folders of the Weibo application and the Taobao application does not change before and after factory settings are restored, functions such as setting in the Weibo application and the Taobao application do not change, so that the user can experience seamless operation experience before and after factory settings are restored.

Alternatively, the foregoing correspondence may be a correspondence list that is newly created when the mobile phone backs up to-be-restored data. For example, when backing up a file named 002 in an “aa” folder in the data partition, the mobile phone modifies the name of the file to 001 and stores the file in the target storage space. Therefore, the mobile phone may record, in the correspondence list, that the file named “001” in the target storage space is corresponding to the file named 002 in the “aa” folder in the data partition. In this way, when the mobile phone subsequently restores the to-be-restored data to the data partition, even if a name of the to-be-restored data is modified when the to-be-restored data is stored in the target storage space, or a storage structure of the to-be-restored data is changed, the mobile phone can still restore, based on the correspondence list, the to-be-restored data in the target storage space to the data partition.

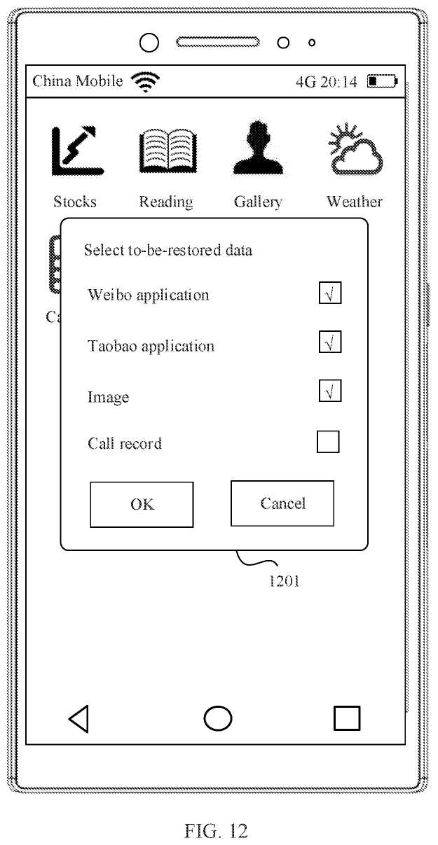

Alternatively, after the mobile phone is restored to factory settings, a to-be-restored data list 1201 shown in FIG. 12 may be displayed, where the to-be-restored data list 1201 includes the one or more pieces of to-be-restored data selected by the user in step S403. The user may select, from the to-be-restored data list 1201, to-be-restored data to be restored to the mobile phone to which factory settings are reset. In other words, the user may select specific data to be backed up during a data backup, or mav select specific data to be restored during data restoration. Therefore, man-machine interaction is more friendly to a user when a mobile phone is restored to factory settings.

Certainly, after being restored to factory settings, the mobile phone may also automatically restore the to-be-restored data in the target storage space to the data partition. For example, in the recovery mode, the mobile phone may copy the to-be-restored data in the target storage space to the data partition. Alternatively, if the mobile phone backs up, in step S405, the to-be-restored data to the new partition that is newly created in the ROM, the to-be-restored data in the new partition is not cleared when the mobile phone exits the recovery mode. In this case, the mobile phone may also exit the recovery mode and enter the normal mode (normal mode) again, and in the normal mode, copy the to-be-restored data in the target storage space to the data partition. This is not limited in the embodiments of this application.

In addition, in the recovery mode, after restoring the to-be-restored data in the target storage space to the data partition, the mobile phone may exit the recovery mode and enter the normal mode (normal mode). For example, after receiving an operation that the user confirms to restart the mobile phone, the mobile phone may be automatically powered off, and then enter the normal mode when the mobile phone is powered on. Because in the recovery mode, the mobile phone has restored the to-be-restored data in the target storage space to the data partition, as shown in FIG. 11, the Weibo application and the Taobao application that are restored after the mobile phone enters the normal mode are re-displayed on the desktop 1101.

Alternatively, if the mobile phone backs up, in step S405, the to-be-restored data to the new partition that is newly created in the ROM, the to-be-restored data in the new partition is not cleared when the mobile phone exits the recovery mode. Therefore, after exiting the recovery mode and entering the normal mode, the mobile phone may also prompt the user to restore, to the mobile phone to which factory settings are reset, the to-be-restored data that is backed up before factory settings are restored. This is not limited in the embodiments of this application.

Certainly, if the user determines not to restore the to-be-restored data any more, the mobile phone may delete the to-be-restored data stored in the target storage space, to release storage resources of the mobile phone. In this case, the mobile phone is completely reset to the factory-default status at which the mobile phone is set for sale. For example, the mobile phone may display the pop-up box shown in FIG. 10 or FIG. 12 for a plurality of times to prompt the user to restore the to-be-restored data. If the user refuses to restore the to-be-restored data for a plurality of times (for example, three consecutive times), the mobile phone may delete the to-be-restored data stored in the target storage space. Alternatively, the mobile phone may store, for a specific period of time (for example, three days), the to-be-restored data stored in the target storage space, and if the mobile phone does not receive, within three days, a user's operation of restoring the to-be-restored data, the mobile phone may delete the to-be-restored data stored in the target storage space.

S408: The mobile phone deletes the to-be-restored data in the target storage space.

In step S408, after restoring the to-be-restored data to the data partition in the ROM in the mobile phone again, the mobile phone may delete the to-be-restored data stored in the target storage space. This prevents the to-be-restored data in the target storage space from occupying system resources of the mobile phone. In addition, if the target storage space is the new partition (for example, the foregoing resume partition) that is dynamically created by the mobile phone when the mobile phone backs up the to-be-restored data, the mobile phone may alternatively destroy the new partition, to prevent the new partition from occupying the system resources of the mobile phone.

For example, if the resume partition is created by the mobile phone in the data partition of the ROM, after destroying the resume partition, the mobile phone may combine storage resources occupied by the resume partition with the current data partition, so that the data partition in the mobile phone may be restored to a status before the mobile phone creates the resume partition.

In addition, if the mobile phone stores the to-be-restored data in the RAM of the mobile phone, because internal data of the RAM is automatically erased after the RAM is powered off, the to-be-restored data in the RAM may be automatically deleted when the mobile phone exits the recovery mode and is restarted.

It can be learned that in the entire process of resetting factory settings provided in this embodiment of this application, the mobile phone may back up, in internal storage space of the mobile phone before being restored to factory settings, to-be-restored data that the user needs to be backed up. After the mobile phone is restored to factory settings, the to-be-restored data is restored from the internal storage space. The entire data backup and restoration process does not depend on external resources such as a Wi-Fi network environment and a cloud server, so that data is more stable and secure during the backup and restoration process, and it is simpler and more convenient for the user to restore the mobile phone to factory settings.

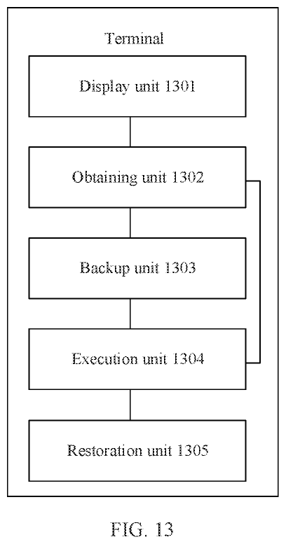

In some embodiments of this application, an embodiment of this application discloses a terminal. As shown in FIG. 13, the terminal is configured to implement the methods recorded in the foregoing method embodiments, and the terminal includes a display unit 1301, an obtaining unit 1302, a backup unit 1303, an execution unit 1304, and a restoration unit 1305. The display unit 1301 is configured to support the terminal in performing the process S402 in FIG. 4; the obtaining unit 1302 supports the terminal in performing the processes S401 and S403 in FIG. 4; the backup unit 1303 is configured to support the terminal in performing the process S405 in FIG. 4; the execution unit 1304 is configured to support the terminal in performing the processes S404, S406, and S408 in FIG. 4; and the restoration unit 1305 is configured to support the terminal in performing the process S407 in FIG. 4. All related content of the steps in the foregoing method embodiments may be cited in function descriptions of the corresponding functional modules. Details are not described herein again.

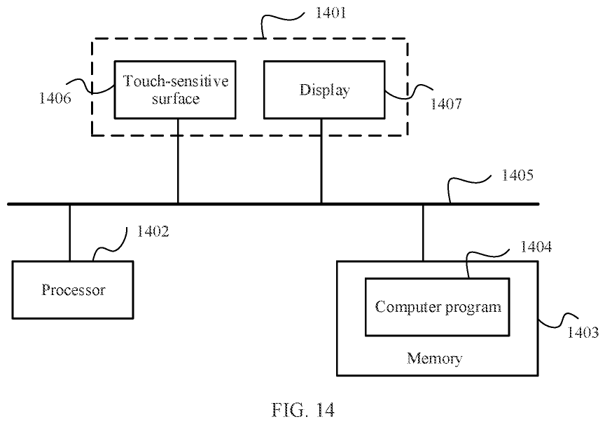

In some other embodiments of this application, an embodiment of this application discloses a terminal, including a processor, and a memory, an input device, and an output device that are connected to the processor. The input device and the output device may be integrated into one device. For example, a touch-sensitive surface may be used as the input device, a display may be used as the output device, and the touch-sensitive surface and the display may be integrated into a touchscreen. In this case, as shown in FIG. 14, the terminal may include the touchscreen 1401, where the touchscreen 1401 includes the touch-sensitive surface 1406 and the display 1407; one or more processors 1402; a memory 1403; one or more applications (not shown); and one or more computer programs 1404. The foregoing devices may be connected through one or more communications buses 1405. The one or more computer programs 1404 are stored in the memory 1403 and are configured to be executed by the one or more processors 1402. The one or more computer programs 1404 include an instruction, and the instruction may be used to perform the steps in FIG. 4 and the corresponding embodiments.

The foregoing descriptions about implementations allow a person skilled in the art to understand that, for a purpose of convenient and brief description, division of the foregoing function modules is taken as an example for illustration. In an actual application, the foregoing functions can be allocated to different modules and implemented based on a requirement, in other words, an inner structure of an apparatus is divided into different function modules to implement all or some of the functions described above. For a detailed working process of the foregoing system, apparatus, and unit, refer to a corresponding process in the foregoing method embodiments, and details are not described herein again.

Functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the embodiments of this application essentially, or the part contributing to the prior art, or all or some of the technical solutions may be implemented in the form of a software product. The software product is stored in a storage medium and includes several instructions for instructing a computer device (which may be a personal computer, a server, or a network device) to perform all or some of the steps of the methods described in the embodiments of this application. The foregoing storage medium includes: any medium that can store program code, such as a flash memory, a removable hard disk, a read-only memory, a random access memory, a magnetic disk, or a compact disc.

The foregoing descriptions are merely specific implementations of the embodiments of this application, but are not intended to limit the protection scope of the embodiments of this application. Any variation or replacement within the technical scope disclosed in the embodiments of this application shall fall within the protection scope of the embodiments of this application. Therefore, the protection scope of the embodiments of this application shall be subject to the protection scope of the claims.

1. A data restoration method implemented by a terminal and comprising:
receiving, from a user, a first input for enabling a function of restoring a factory settings;
displaying a piece of candidate data in response to the first input;
receiving, from the user, a second input for selecting to-be-restored data from the candidate data, wherein the to-be-restored data are located in a storage directory;
backing up the to-be-restored data to target storage space that is not formatted when the factory settings are restored;
performing an operation of restoring to the factory settings; and
restoring, after performing the operation, the to-be-restored data from the target storage space to the storage directory.

2. The data restoration method claim 1, wherein the candidate data comprise at least one of a contact, a short message service (SMS) message, a picture, a video, a call record, music or an application.

3. The data restoration method claim 1, wherein before backing up the to-be-restored data, the data restoration method further comprises determining that the target storage space is an unoccupied storage space in a random-access memory (RAM) when a first size of the to-be-restored data is less than a second size of the unoccupied storage space.

4. The data restoration method of claim 1, wherein after receiving the second input, the data restoration method further comprises marking the to-be-restored data.

5. The data restoration method of claim 4, further comprising recording an initial storage path of the storage directory in a preset backup list.

6. The data restoration method of claim 5, further comprising:
obtaining the to-be-restored data based on the initial storage path; and
copying the to-be-restored data to the target storage space.

7. The data restoration method of claim 1, wherein after receiving the second input, the data restoration method further comprises:
comparing a first size of the to-be-restored data with a third size of an unoccupied storage space in the target storage space; and
prompting the user to deselect a portion of the to-be-restored data when the first size is greater than the third size.

8. The data restoration method of claim 7, wherein before backing up the to-be-restored data, the data restoration-method further comprises determining that the first size is not greater than the third size.

9. The data restoration method of claim 1, wherein before backing up the to-be-restored data, the data restoration method further comprises:
creating a new partition in a read-only memory (ROM) of the terminal based on a first size of the to-be-restored data, wherein the new partition is the target storage space; and
further backing up the to-be-restored data from an original storage space to the new partition.

10. The data restoration method of claim 9, wherein the new partition comprises an unoccupied storage space in a data partition in the ROM.

11. The data restoration method of claim 10, wherein before creating the new partition in the ROM, the data restoration method further comprises deleting data other than the to-be-restored data in the data partition.

12. The data restoration method of claim 11, further comprising:
storing a correspondence between the to-be-restored data in the target storage space and the to-be-restored data in the storage directory; and
further restoring the to-be-restored data from the target storage space to the storage directory according to the correspondence.

13. The data restoration method of claim 1, wherein after performing the operation, the data restoration method further comprises:
displaying a to-be-restored data list;
obtaining, from the user, a third input for selecting second to-be-restored data from the to-be-restored data list; and
restoring the second to be-restored data to a second storage directory of the second to-be-restored data.

14.-23. (canceled)

24. A terminal comprising:
a memory configured to store instructions; and
a processor coupled to the memory and configured to execute the instructions to:
receive, from a user, a first input for enabling a function of restoring to factory settings,
display a piece of candidate data in response to the first input,
receive, from the user, a second input for selecting to-be-restored data from the candidate data, wherein the to-be-restored data are located in a storage directory,
back up the to-be-restored data to a target storage space that is not formatted when the factory settings are restored,
perform an operation of restoring the factory settings, and
restore, after performing the operation, the to-be-restored data from the target storage space to the storage directory.

25. A computer program product comprising computer-executable instructions stored on a non-transitory computer-readable storage medium that, executed by a processor, cause a terminal to:
receive, from a user, a first input for enabling a function of restoring to factory settings,
display a piece of candidate data in response to the first input,
receive, from the user, a second input for selecting to-be-restored data from the candidate data, wherein the to-be-restored data are located in a storage directory,
back up the to-be-restored data to a target storage space that is not formatted when the factory settings are restored,
perform an operation of restoring the factory settings, and
restore, after performing the operation, the to-be-restored data from the target storage space to the storage directory.

26. (canceled)

27. The computer program product of claim 25, wherein the candidate data comprise at least one of a contact, a short message service (SMS) message, a picture, a video, a call record, music, or an application.

28. The computer program product of claim 25, wherein before backing up the to-be-restored data, the instructions further cause the terminal to determine that the target storage space is an unoccupied storage space in a random-access memory (RAM) when a first size of the to-be-restored data is less than a second size of the unoccupied storage space.

29. The computer program product of claim 25, wherein after receiving the second input, the instructions further cause the terminal to mark the to-be-restored data.

30. The data restoration method of claim 1, wherein before backing up the to-be-restored data, the data restoration method further comprises determining that the target storage space is an unoccupied storage space in a read-only memory when a first size of the to-be-restored data is less than a fourth size of the unoccupied storage space.

31. The data restoration method of claim 1, wherein before backing up the to-be-restored data, the data restoration method further comprises determining that the target storage space comprises a first unoccupied storage space in a read-only memory (ROM) and a second unoccupied storage space in a random-access memory (RAM) when a first size of the to-be-restored data is greater than a second size of a first remaining space, is greater than a fourth size of a second remaining space, and is less than a sum of the second size and the fourth size.
